(19) United States
(12) Patent Application Publication
(10) Pub. No.: US 2005/0090771 A1
(43) Pub. Date: Apr. 28, 2005

(54) Massaging machine

(75) Inventor: Akitoshi Miki, Ibaraki (JP)

Correspondence Address: BEYER WEAVER & THOMAS LLP, P.O. BOX 70250, OAKLAND, CA, 94612-0250, US

(73) Assignee: OMRON HEALTHCARE CO., LTD.

(21) Appl. No.: 10/975,178

(22) Filed: Oct. 27, 2004

(30) Foreign Application Priority Data
Oct. 28, 2003 (JP) 2003-367447

(51) Int. Cl. A61H 15/00

(52) U.S. Cl. 601/99; 601/102; 601/108

(57) ABSTRACT

A massaging machine includes a massaging unit having massaging balls for contacting a patient and a massaging shaft that is rotationally driven and causes the massaging balls to undergo massaging motions and a lifting shaft that is rotated for moving the massaging unit along guide devices. Pinions are fixed to the lifting shaft and engage racks on the guide devices. Eccentric collars are supported by the lifting shaft and their outer peripheries support link holders rotatably. Arm-supporting members supporting the massaging balls are axially supported by the massaging shaft and are connected to the link holders. Phase difference in the rotary motions of the eccentric collars is varied by the direction of rotation of a motor for the eccentric collars.

Priority is claimed on Japanese Patent Application 2003-367447 filed Oct. 28, 2003.

### BACKGROUND OF THE INVENTION

This invention relates to a massaging machine and more particularly to the structure of its massaging mechanism.

It has been known to form the kneading mechanism of a massaging machine by using sectionally U-shaped guide rails on the right-hand and left-hand side of a frame and using rollers, racks and pinions to provide vertical motions.

Japanese Patent Publication Tokkai 63-145656, for example, discloses a massaging machine with a massaging shaft which is hollow and through which a lifting shaft is passed. Attached to each end part of the lifting shaft are a rotatable roller and a pinion affixed to the shaft. An eccentric shaft for pounding operations is inside a force-adjusting mechanism, and its eccentric part and an end part of the massaging arm are connected by a link. Another pair of rotatable rollers is affixed to the frame of the massaging part through supporting shafts for the aforementioned rotatable rollers. The structure thus described is supported by and attached to the frame.

Japanese Patent Publication Tokkai 7-323052 discloses another massaging machine provided with a rotatable roller at both end parts of the massaging shaft and a lifting shaft is provided separately through a decelerator. At each end part of the lifting shaft are a rotatable roller and a pinion affixed to the shaft. A pounding shaft for the pounding operation is provided separately through a decelerator. There is an eccentric top at the center of the pounding shaft, and the link support and the end part of the massaging arm are connected by a link through a bearing. These shafts and the decelerator in this example are supported by a large frame.

Japanese Patent Publications Tokkai 11-332942 and 2001-224644 disclose still another massaging machine provided with a pounding function. Its lifting mechanism is structured such that rollers and pinion shafts are supported by a unit case and the pinion shafts are rotated by means of a worm decelerator. It is also provided with a large molded resin case for supporting the massaging and pounding mechanisms as well as the lifting mechanism.

According to the technologies of aforementioned Japanese Patent Publications Tokkai 63-145656 and 7-323052, the supporting part for the link for controlling the rotation of the massaging arm and the pounding operations is provided to the shaft dedicated to the pounding operations. Such a massaging mechanism requires a dedicated shaft for the pounding and a bearing structure for rotatably supporting the shaft. Since the pounding operations are carried out at a fast rate, large impulse loads are generated and communicated to the pounding shaft. Thus, a shaft with a relatively large diameter is required and this means that an accordingly large bearing is needed. Moreover, the frame that supports this bearing must be made stronger and hence tends to become a large and heavy structure.

According to the technology of aforementioned Japanese Patent Publications Tokkai 11-332942 and 2001-224644, the link is provided so as to be three-dimensionally rotatable at a portion of the support structure of a massaging mechanism for controlling the rotation of the massaging arm. In such a massaging mechanism, since the link must be able to support the large reaction force received from the patient's body by the massaging balls, the support structure must be structured so as to withstand this large force. As a result, the support structure tends to become structurally complicated as the thickness is increased in the case of a molded produce or as more ribs are used or iron plates are used besides a resin material for increasing the strength. Since the link undergoes a three-dimensional motion, furthermore, a ball joint structure becomes necessary and the end part of the link has the shape of a ball. Thus, a cover structure for holding this ball-shaped structure becomes necessary, and this causes the structure to become complicated and the number of parts to increase.

### SUMMARY OF THE INVENTION

It is therefore an object of this invention to address these technical problems and to provide a massaging machine with a massaging mechanism structured such that it can be made compact and lighter and hence that its production cost can be reduced.

A massaging machine embodying this invention in view of the object of the invention described above, may be characterized as comprising a massaging unit including massaging balls for contacting a patient, a massaging shaft that is rotationally driven for causing the massaging balls to undergo massaging motions, a massaging power source that provides rotary power and rotationally drives the massaging shaft and a rotation-massaging conversion device that converts the rotary power of the massaging power source into the massaging motions of the massaging balls and a lifting mechanism for moving the massaging unit along guide devices, the lifting mechanism including a lifting shaft that is rotated for moving the massaging unit, a moving power source for rotationally driving the lifting shaft and a motion converting device for converting rotary motion of the lifting shaft into movement of the lifting mechanism, wherein the rotation-massaging conversion device includes a rotation control device that is connected to the lifting shaft and serves to limit rotation of the rotation-massaging conversion device around the massaging shaft.

With a massaging mechanism thus structured, there is no need to provide a special component for limiting the rotation of the rotation-massaging conversion device around the massaging shaft and hence a massaging machine can be made thinner and more compact.

It is preferable that the massaging unit further includes pounding rotary bodies that are supported rotatably by the lifting shaft and are rotationally driven for causing the massaging balls to undergo pounding motions, a pounding power source that provides rotary power for rotationally driving the pounding rotary bodies, and a rotation-pounding conversion device that converts rotary motions of the pounding rotary bodies into the pounding motions of the massaging balls.

With the massaging unit thus structured, there is no need to provide any shaft specifically for supporting the pounding rotary bodies and since it becomes easier to arrange these components, the massage machine as a whole can be made compact and lighter and hence the production cost can be reduced.

It is also preferable to further provide a mode switching mechanism for switching between different modes of the pounding motions by varying direction of rotationally driving the pounding rotary bodies because the switching between the modes of pounding can be effected by a simple operation of merely changing the direction of rotation of the pounding power source.

According to a preferred embodiment, the massaging balls consist of first massaging balls and second massaging balls, the pounding rotary bodies consist of a first rotary body that moves the first massaging balls and a second rotary body that moves the second massaging balls, and the massaging machine further comprises a first power transmission system that transmits the rotary power of the pounding power source to the first rotary body and a second power transmission system that transmits the rotary power of the pounding power source to the second rotary body. In the above, a single motor with two drive shafts may be used as the power source of both the first and second power transmission systems or two different power sources may be used.

Each of these power transmission systems may comprise a toothed belt that is driven by the pounding power source and toothed pulleys around which the belt is wound such that the first rotary body and the second rotary body are rotated by rotary power communicated to the pulleys. With the power transmission systems thus structured, they can be operated dependably at their intended timings and the massaging machine can be accurately controlled. The belts used in these power transmission systems may be helical belts and their pulleys may be helical pulleys with matching teeth such that the noise of operation can be reduced while operations at accurate timings can be assured. The belts and the pulleys may be provided with sectionally V-shaped grooves.

The deceleration ratio of the two power transmission systems may be different such that the phase difference in the pounding motions of the first and second massaging balls will change periodically and the patient can enjoy a variety of modes of pounding.

It is further preferable to provide the massaging shaft with supporting devices for supporting the massaging unit against the guide devices. With such supporting devices provided to the massaging shaft, there is no need for a frame structure or a case structure specifically for supporting the massaging unit and hence the massaging machine as a whole can be made more compact.

If both the massaging power source and the moving power source are disposed between the massaging shaft and the lifting shaft, the number of machine components can be reduced and since the distance of required wiring is reduced, this also allows the massaging machine as a whole to be made compact and lighter.

### BRIEF DESCRIPTION OF THE DRAWINGS

FIG. 1 is a diagonal view taken from the front right-hand side of a massaging machine embodying this invention.

FIG. 2 is a sectional view of the massaging machine of FIG. 1.

FIG. 3 is a side view of the massaging machine of FIG. 1 taken from its left-hand side.

FIG. 4A is a front view of the massaging unit embodying this invention and FIG. 4B is its side view taken from the right-hand side.

FIG. 5 is a sectional view of the massaging unit taken along line 5-5 of FIG. 4B.

FIG. 6 is a diagonal back view of the massaging unit taken from the left-hand side.

FIG. 7 is a diagonal back view of the massaging unit taken from the right-hand side to show its internal structure.

FIG. 8 is a diagonal back view of the massaging unit taken from the left-hand side to show its internal structure.

FIG. 9 is a diagonal back view of the massaging unit taken from the right-hand side.

FIG. 10 is a diagonal frontal view of the massaging unit taken from the right-hand side.

FIG. 11 is a diagonal frontal view of the massaging unit taken from the left-hand side.

FIG. 12A is a sectional view of the pounding mode switching mechanism for the massaging unit taken along the lifting shaft and FIG. 12B is a sectional view taken along line 12B-12B of FIG. 12A when the pounding motor is rotated in the counter-clockwise direction as seen from the side of the small pulley.

FIG. 13A is a sectional view of the pounding mode switching mechanism for the massaging unit taken along the lifting shaft and FIG. 13B is a sectional view taken along line 13B-13B of FIG. 13A when the pounding motor is rotated in the clockwise direction as seen from the side of the small pulley.

### DETAILED DESCRIPTION OF THE INVENTION

The invention is described next by way of an example with reference to the drawings. The lifting mechanism and the massaging mechanism will be described first, followed by the explanation of the pounding mechanism and the switching mechanism for simultaneous and alternate pounding.

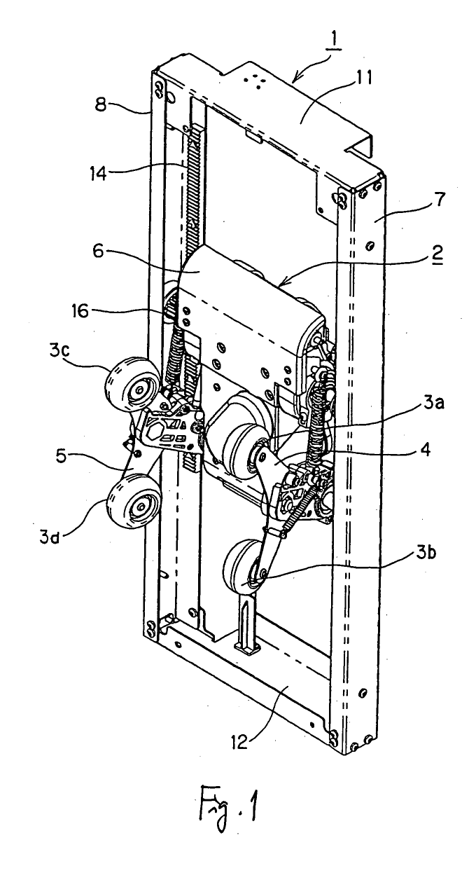

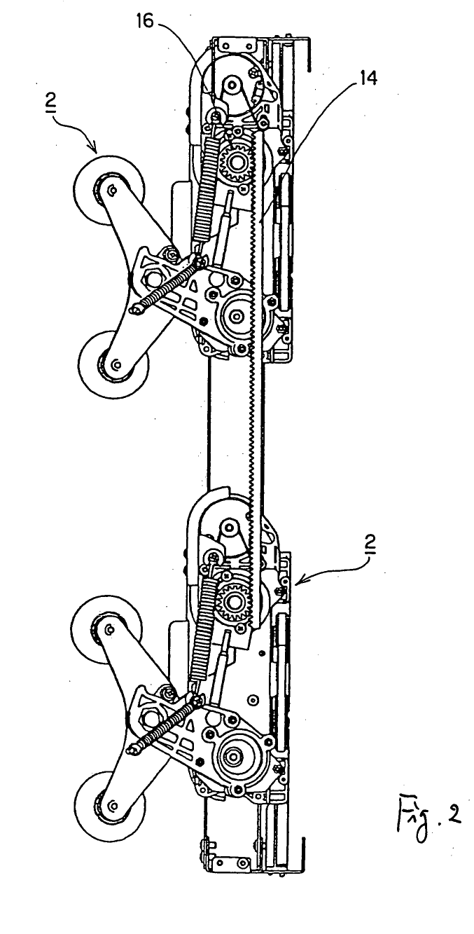

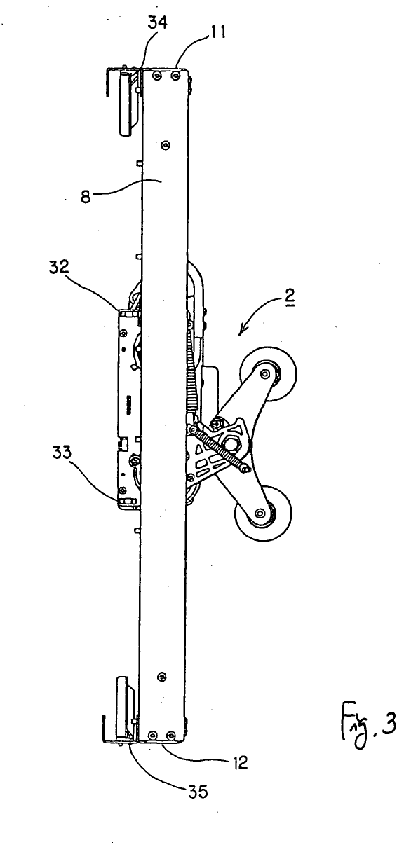

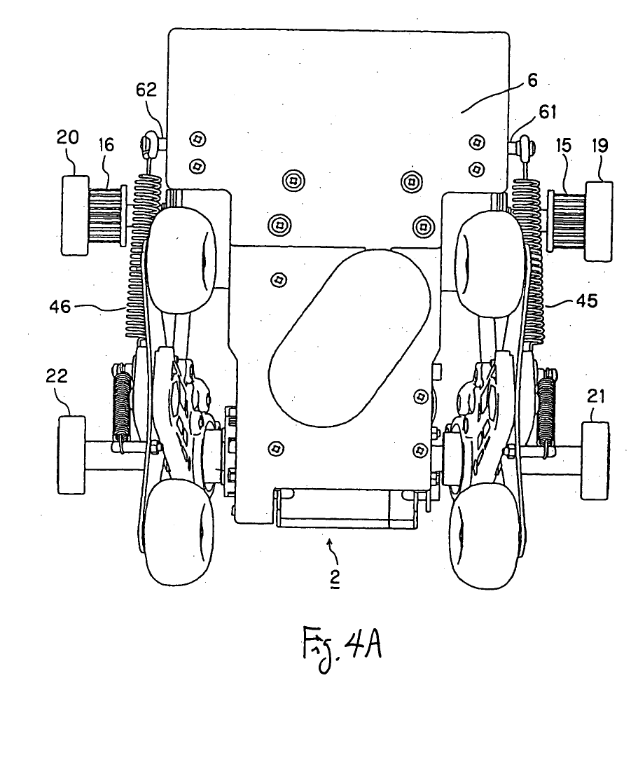

FIG. 1 is a diagonal view taken from the front right-hand side of a massaging machine 1 embodying this invention, FIG. 2 is its sectional view taken from its center towards its left-hand side, and FIG. 3 is its side view taken from the left-hand side. This massaging machine 1 is intended to be used, for example, in the back portion of a massaging chair such that therapies involving massaging and pounding can be carried out.

Numeral 2 indicates a massaging unit 2 of the massaging machine 1, provided with four massaging balls 3a, 3b, 3c and 3d which are arranged up and down on the right-hand and left-hand sides and each rotatably supported at a tip of one of generally V-shaped ball-supporting arms 4 and 5. In what follows, the direction in which the massaging balls 3a-3d protrude is referred to as the front, and the right-hand and left-hand sides are defined as one faces the massaging balls 3a-3d from the front. A cover 6 is provided on the front surface side from the upper part to the lower part between the massaging balls on the right-hand and left-hand sides for protecting motors and pulleys placed behind.

The massaging unit 2 is adapted to move up and down along a pair of lifting guides (“guide devices”) 7 and 8 placed on its right-hand and left-hand sides. The lifting guides 7 and 8 are each sectionally U-shaped and are disposed such that their opening parts face each other, supported by supporting plates 11 and 12, respectively at the top and at the bottom. Vertically extending racks 13 and 14 are disposed on the back inner side surfaces of the lifting guides 7 and 8, respectively so as to be mutually symmetrically positioned.

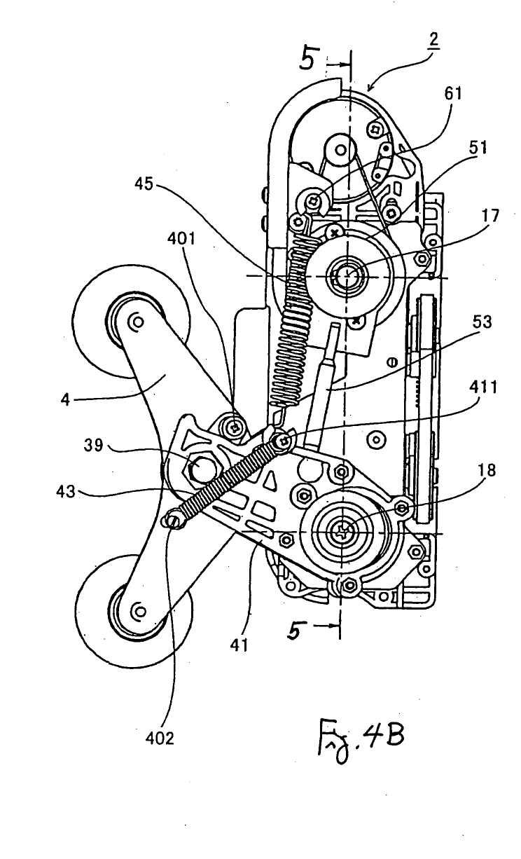

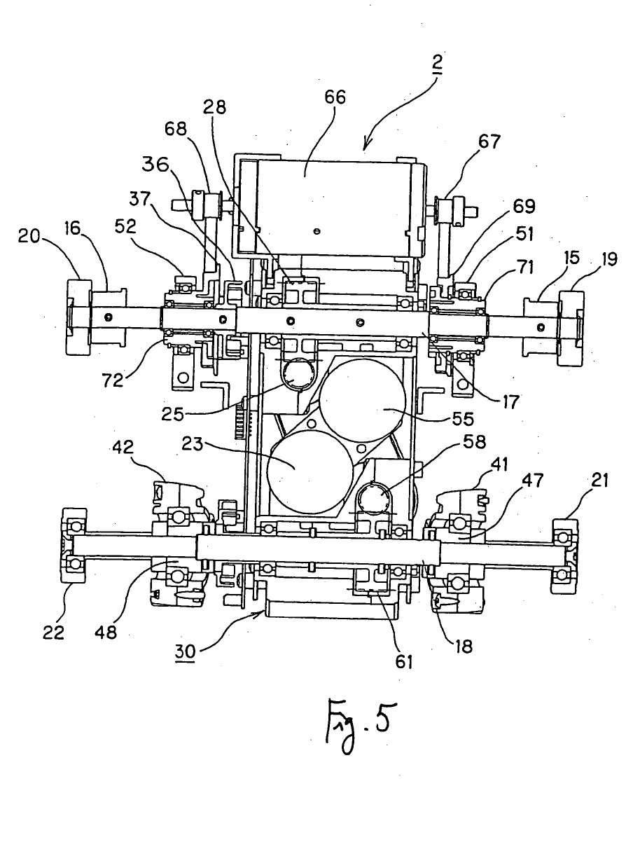

FIGS. 4A and 4B are respectively a front view and a right-hand side view of the massaging unit 2 and FIG. 5 is its sectional view taken along line 5-5 of FIG. 4B. Numerals 15 and 16 indicate pinions engaging the racks 13 and 14, respectively, being affixed to the right-hand and left-hand end parts of a shaft (“lifting shaft”) 17. Rollers 19, 20, 21 and 22 are rotatably supported at the right-hand and left-hand end parts of the lifting shaft 17 and another shaft (massaging shaft) 18. As the massaging unit 2 moves up and down, these rollers 19, 20, 21 and 22 rotate along the inner front surfaces of the lifting guides 7 and 8. The rollers 21 and 22 may be referred to also as “supporting devices”.

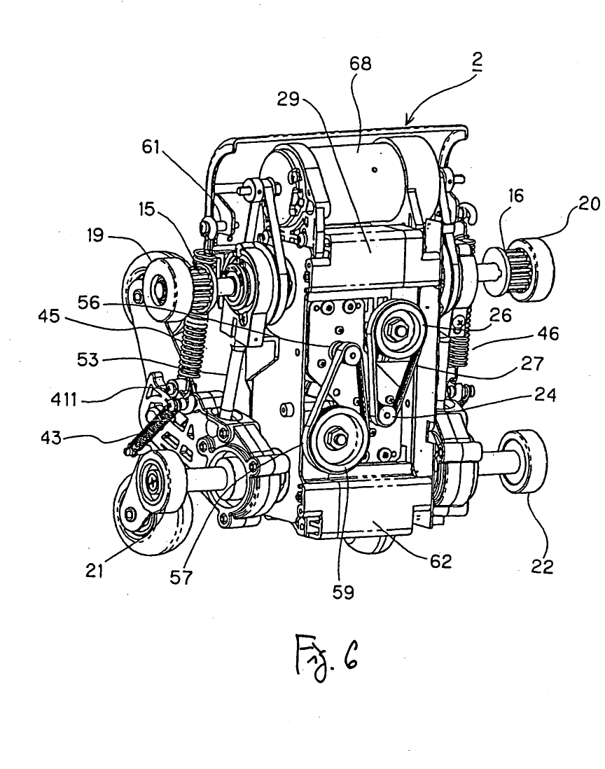

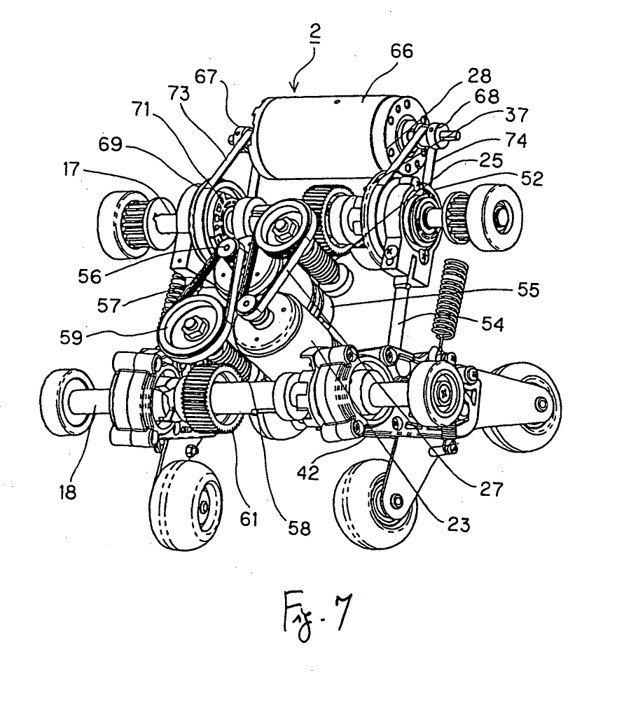

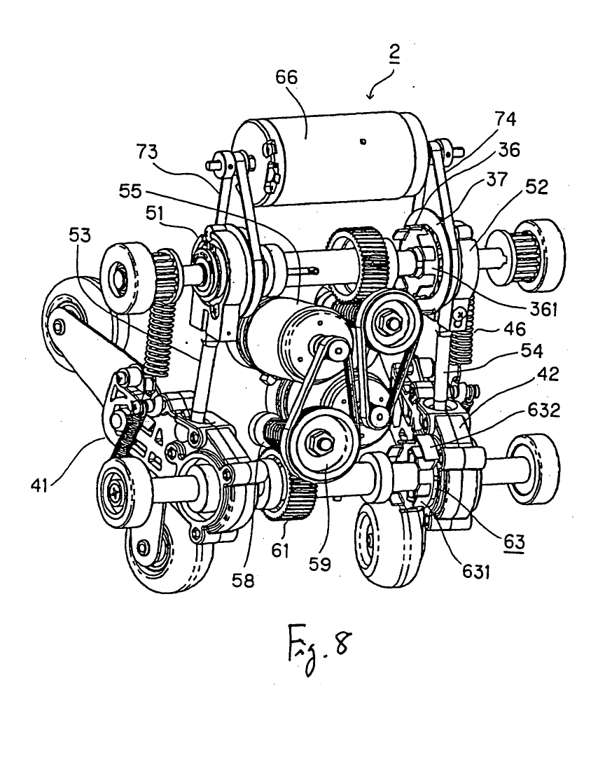

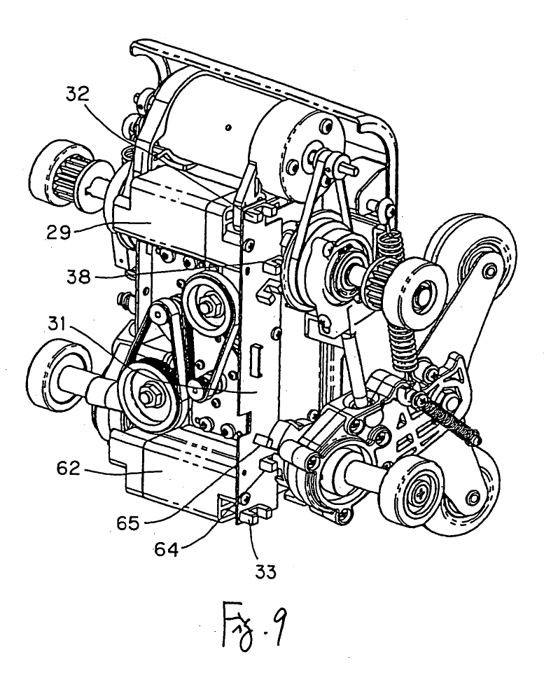

FIG. 6 is a view of the massaging unit 2 taken diagonally from the left-hand back side, and FIG. 7 is another view taken diagonally from the right-hand back side to show its internal structure. FIG. 8 is still another view taken diagonally from the left-hand back side to show its internal structure, and FIG. 9 is still another view taken diagonally from the right-hand back side.

Numeral 23 indicates a lifting motor (“moving power source”) disposed in the front-back direction at a lower position at the center of the massaging unit 2 between the lifting shaft 17 and the massaging shaft 18. The output shaft of the lifting motor 23 protrudes to the backside of the massaging unit 2 where a small pulley 24 is attached. A worm gear 25 is disposed above the lifting motor 23 so as to be parallel thereto. A large pulley 26 (larger than the aforementioned small pulley 24) is attached to the back end of the worm gear 25 such that the rotary driving force of the lifting motor 23 is communicated to the worm gear 25 through an endless transmission belt 27 stretched between the aforementioned small and large pulleys 24 and 26.

A worm wheel 28 is attached to the outer peripheral surface of the lifting shaft nearly at its center and engages with the worm gear 25. Thus, the rotary driving force of the lifting motor 23 is transmitted through the small pulley 24, the endless transmission belt 27, the large pulley 26, the worm gear 25 and the worm wheel 28 to cause the lifting shaft 17 to rotate. The worm gear 25 and the worm wheel 28 are contained inside a gear case 29.

As the lifting shaft 17 is rotationally driven, the pinions 15 and 16 at its end parts are also rotated. Since these pinions 15 and 16 engage with the racks 13 and 14 on the lifting guides 7 and 8, the massaging unit 2 moves upward or downward along the lifting guides 7 and 8 as a result of the rotary motion of the lifting shaft 17. Thus, the lifting shaft 17 is hereinafter also referred to as the “rotary shaft for transportation”, the racks 13 and 14 and the pinions 15 and 16 are also referred to as the “motion converting devices”, and the lifting shaft 17, the racks 13 and 14, the pinions 15 and 16 and the lifting motor 23 are together referred to as forming a “unit transporting mechanism” for moving the massaging unit 2.

In FIG. 9, numeral 31 indicates a sensor-supporting board attached to the left-hand side surfaces of the gear case 29 and another case 62, having limit sensors 32 and 33 attached thereto. As shown in FIG. 3, dogs 34 and 35 are attached to the upper and lower supporting plates 11 and 12 at positions corresponding to the limit sensors 32 and 33. As the massaging unit 2 moves upward along the lifting guides 7 and 8 and the upper limit sensor 32 detects the dog 34 attached to the upper supporting plate 11, the upper limit of the upward motion of the massaging unit 2 is acknowledged. Similarly, as the massaging unit 2 moves downward along the lifting guides 7 and 8 and the lower limit sensor 33 detects the dog 35 attached to the lower supporting plate 12, the lower limit of the downward motion of the massaging unit 2 is acknowledged.

As shown in FIG. 8, a disc-shaped rotation sensor dog 36 is affixed to the outer periphery of the lifting shaft 17, positioned inside (on the right-hand side) of a pulley 37 (referred to as the collar-integrated pulley) on the left-hand side of the lifting shaft 17. The disc-shape of this rotation sensor dog 36 has its peripheral edge part bent into the axial direction and is cut at specified intervals around the circumference such that rectangular protrusions 361 are arranged circumferentially.

A rotation sensor 38 is attached to the sensor-supporting board 31 at a position corresponding to the rotation sensor dog 36, having a light-emitting part and a light-receiving part (not shown) and being adapted to detect any interruption in the optical path for light from the light-emitting part to the light-receiving part by the protrusion 361 on the rotation sensor dog 36. The rotary angle of the lifting shaft 17 can thus be counted.

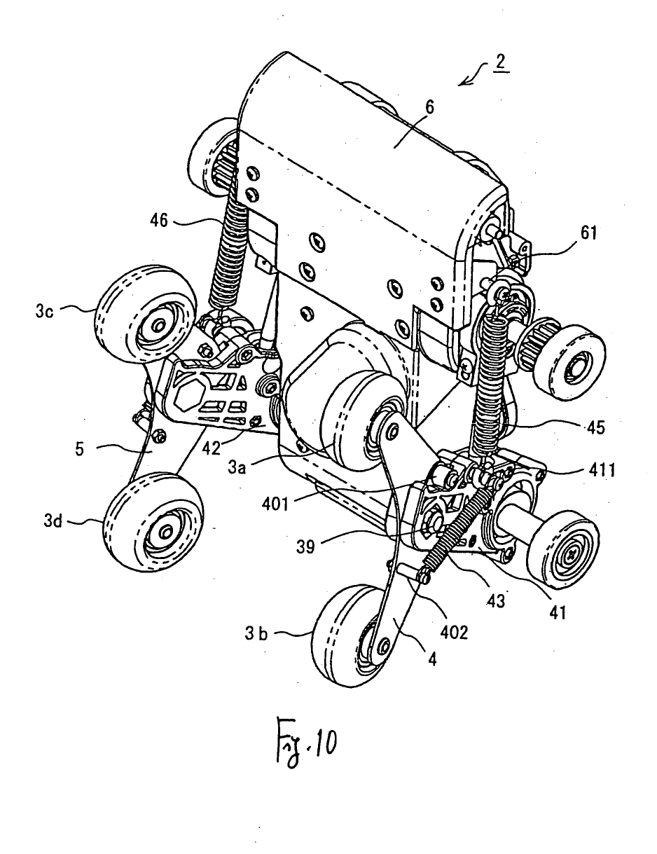

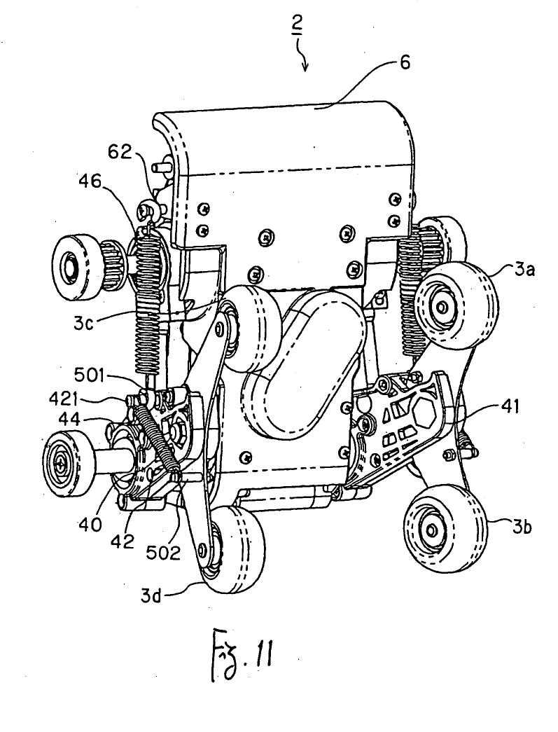

FIGS. 10 and 11 are respectively a frontal right-hand and left-hand diagonal view of the massaging unit 2, showing the four massaging balls 3a-3d arranged in two rows up and down and in two columns to the right and to the left, each rotatably supported at a tip of one of the generally V-shaped ball-supporting arms 4 and 5, as explained above. The generally V-shaped ball-supporting arms 4 and 5 are rotatably supported at their centers by arm-supporting members 41 and 42 around rotary shafts 39 and 40, respectively. The rotary motions of the ball-supporting arms 4 and 5 are constrained by means of stoppers 401 and 501 which are adapted to come to contact the arm-supporting members 41 and 42 to limit the rotary motions of the arm-supporting members 41 and 42.

Outwardly protruding columnar members 411, 421, 402 and 502 are provided outside the arm-supporting members 41 and 42 and below and outside the ball-supporting arms 4 and 5. Coil springs 43 and 44 are stretched between these columnar members so as to provide a biasing diagonally upward force on the lower parts of the ball-supporting arms 4 and 5. Thus, unless there is an external force, the upper massaging balls 3a and 3c normally protrude forward and the lower massaging balls 3b and 3d remain in their backward retracted positions.

The upper side surfaces of the cover 6 is also provided with outwardly protruding columnar members 61 and 62. Sound-suppressing springs 45 and 46 are stretched between this pair of columnar members 61 and 62 and another pair of columnar members 411 and 421 on the arm-supporting members 41 and 42. These sound-suppressing springs 45 and 46 provide a biasing upward force on the arm-supporting members 41 and 42, thereby serving to absorb the vibrations of the arm-supporting members 41 and 42 when they are undergoing a pounding operation and to suppress the sound of the pounding.

As shown in FIG. 5, cylindrically shaped sleeves 47 and 48 are on the right-hand and left-hand sides of the massaging shaft 18, affixed so as to be symmetrically sloped with respect to the axial direction and eccentric in the radial direction. The arm-supporting members 41 and 42, which are made of a resin material, are rotatably engaged around the outer periphery of these sloped sleeves 47 and 48 through bearings.

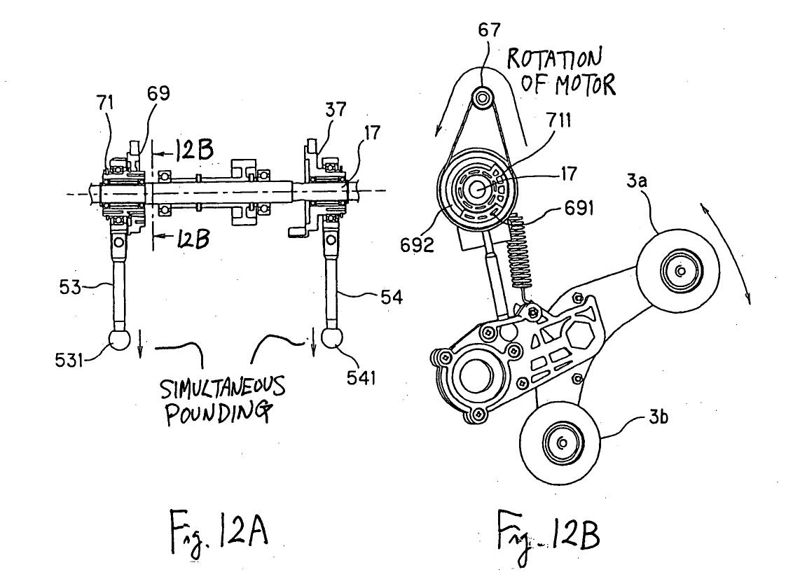

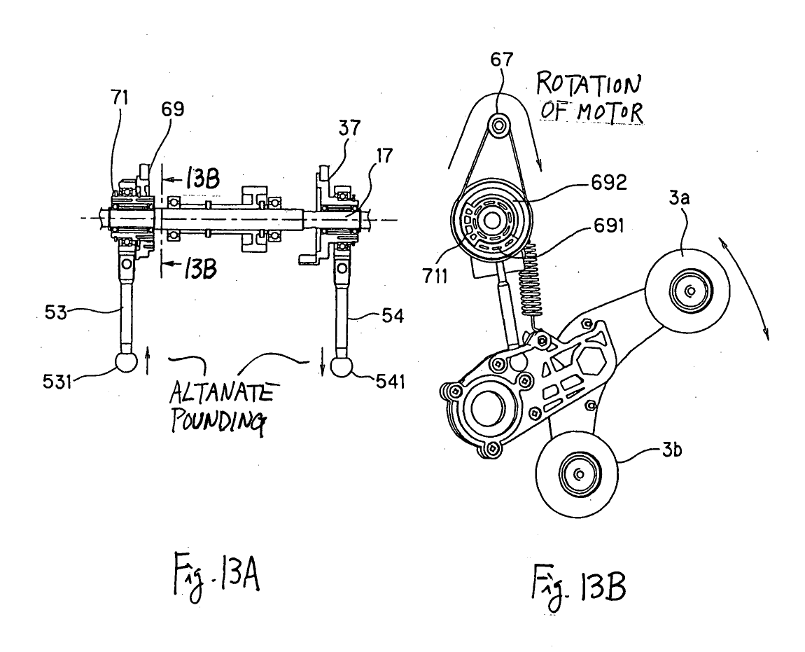

On both right-hand and left-hand sides of the lifting shaft 17, which is placed parallel to and above the massaging shaft 18, link holders 51 and 52 are disposed rotatably around the outer peripheries of eccentric collars 71 and 72 (to be described below) through bearings at positions corresponding to the sloped sleeves 47 and 48, respectively. These link holders 51 and 52 are connected to the arm-supporting members 41 and 42 by links 53 and 54. As shown in FIGS. 6-8, these links 53 and 54 are connected to the lifting shaft 17 so as to be able to swing in the axial direction. As shown in FIGS. 12A and 13A, their end parts 531 and 541 on the side of the arm-supporting members 41 and 42 are each formed in a spherical shape such that the links 53 and 54 can swing around the arm-supporting members 41 and 42 over these spherical surfaces while limiting the rotation of the arm-supporting members around the massaging shaft 18. Both the lifting shaft 17 and the massaging shaft 18 are supported rotatably with respect to the massaging unit 2 through bearings.

A massaging motor 55 is disposed between the lifting shaft 17 and the massaging shaft 18, diagonally above the lifting motor 23. As shown in FIGS. 6 and 7, a small pulley 56 is attached to its output shaft and an endless transmission belt 57 is stretched around and between this small pulley 56 and a larger pulley 59 attached to the shaft of a worm gear 58 disposed below and parallel to the massaging motor 55 in the front-back direction. A worm wheel 61 engages with this worm gear 58 and is affixed to the outer periphery of the massaging shaft 18. Both the worm gear 58 and the worm wheel 61 are contained inside the gear case 62.

As shown in FIG. 8, a disc-shaped massaging sensor dog 63 is disposed on the outer periphery of the massaging shaft 18 at a position inside the left-hand arm-supporting member 42. Like the disc-shaped rotation sensor dog 36, the massaging sensor dog 63 also has a disc-shaped part with a uniform diameter and a protruding part protruding radially from the disc-shaped part. The peripheral portion of the disc-shaped part is bent in the axial direction and is cut at specified intervals around the circumference such that rectangular detection targets 631 are arranged circumferentially. Alternatively, there may be only one detection target 631. A rectangular origin detection target 632 is formed by bending the outer peripheral part of the protruding part into the axial direction. As shown in FIG. 9, a massaging shaft rotation sensor 64 and an origin detection sensor 65, which respectively correspond to the detection target 631 and the origin detection target 632, are both disposed on the sensor-supporting board 31 opposite the sensor dog 63. Both the massaging shaft rotation sensor 64 and the origin detection sensor 65 are adapted to detect the interruption of the optical path for light from a light-emitting part to a light-receiving part by a detection target and to thereby detect the rotation of the massaging shaft 18 and its reference position (origin).

As the massaging motor 55 is rotationally driven such that the massaging shaft 18 is rotated, the massaging balls 3a-3d move along three-dimensional tracks because the arm-supporting members 41 and 42 are rotatably engaged with the outer peripheries of the sloped sleeves 47 and 48 and connected to the links 53 and 54 supported on the link holders 51 and 52 on the lifting shaft 17 so as to be able to freely swing around. It is to be noted that the massaging balls 3a and 3b on the right-hand side and the massaging balls 3c and 3d on the left-hand side move such that the separation between them vary as they move. The pounding motor 66 (to be described below) is usually stopped during a pounding operation but it need not be stopped.

For the convenience of the present invention, the arm-supporting members 41 and 42, the sloped sleeves 47 and 48, the links 53 and 54 and the link holders 51 and 52 may be together referred to as the rotation-massaging conversion device, and the links 53 and 54 and the link holders 51 and 52 may be together referred to as the rotation control device for the rotation-massaging conversion device.

The pounding operation by the massaging unit 2 is carried out through the lifting shaft 17 disposed in the right-left direction in the upper portion of the massaging unit 2.

As shown in FIG. 5, there is a motor (referred to as the pounding motor and also as the pounding power source) 66 disposed in the right-left direction at an upper part of the massaging unit 2. Small pulleys 67 and 68 are attached to the two output shafts of the pounding motor 66. A pulley, referred to as the pounding mode switching pulley 69, is on the right-hand side of the lifting shaft 17, and the aforementioned collar-integrated pulley 37 is on the left-hand side of the left-hand side. The pounding mode switching pulley 69 and the collar-integrated pulley 37 are each a toothed pulley. The pounding mode switching pulley 69 is rotatably supported through a bearing by the outer periphery of eccentric collar 71 rotatably supported on the right-hand side of the lifting shaft 17. The collar-integrated pulley 37 is formed integrally as a single member with the eccentric collar 72 rotatably supported on the left-hand side of the lifting shaft 17.

An endless transmission belt 73 is wound around the small pulley 67 on the output shaft protruding to the right from the pounding motor 66 and the pounding mode switching pulley 69. Another endless transmission belt 74 is wound around the small pulley 68 on the output shaft protruding to the left from the pounding motor 66 and the collar-integrated pulley 37. Both of these endless transmission belts 73 and 74 are toothed belts.

For the convenience of the present invention, the right-hand small pulley 67, the pounding mode switching pulley 69 and the transmission belt 73 are said to together form a first power transmission system, and the left-hand small pulley 68, the collar-integrated pulley 37 and the transmission belt 74 are said to together form a second power transmission system.

The aforementioned eccentric collars 71 and 72 are respectively on the left-hand side and the right-hand side of the lifting shaft 17, each having a cylindrical outer peripheral surface which is eccentric with respect to the center axis of the lifting shaft 17. The link holders 51 and 52 are disposed rotatably around the outer peripheries of the eccentric collars 71 and 72 through bearings.

As the pounding motor 66 is rotationally driven to cause the eccentric collars 71 and 72 to rotate, the link holders 51 and 52 are displaced along the lifting shaft 17 by a distance depending on the eccentricity of the eccentric collars 71 and 72, undergoing reciprocating motions. Since the links 53 and 54 connect the link holders 51 and 52 with the arm-supporting members 41 and 42, this motion of the link holders 51 and 52 is communicated to the arm-supporting members 41 and 42. Since the arm-supporting members 41 and 42 are rotatably engaging with the outer peripheries of the sloped sleeves 47 and 48, the arm-supporting members 41 and 42 undergo reciprocating motions around the sloped sleeves 47 and 48, causing the massaging balls 3a-3d to move reciprocatingly to carry out the pounding operations.

For the convenience of the present invention, the eccentric collars 71 and 72 are also referred to as the first pounding rotary body and the second pounding rotary body, respectively, and the link holders 51 and 52, the links 53 and 54 and the arm-supporting members 41 and 42 are also together referred to as the rotation-pounding converting device.

Next, the pounding mode switching mechanism for the massaging unit 2 is explained with reference to FIG. 12A which is its sectional view along the lifting shaft 17 and FIG. 12B which is another sectional view, showing the condition when the pounding motor 66 is rotated in the counter-clockwise direction as seen from the side of the small pulley 67.

The inner end surface of the pounding mode switching pulley 69 is formed in the shape of having a portion left in the circumferential direction and the remaining parts removed. In other words, there are fan-shaped protrusions 691 spanning a specified angular range and a fan-shaped space 692 formed over the remaining angular range.

The inner end part of the eccentric collar 71 in the axial direction is positioned on the side of the inner diameter of the pounding mode switching pulley 69. A protrusion 711 in the radial direction is formed on its outer peripheral surface, being also fan-shaped and extending in the circumferential direction with respect to the center of the lifting shaft 17. The protrusion 711 is at a position in the radial direction corresponding to the aforementioned protrusions 691 and the space 692 with respect to the center of the lifting shaft 17. The pounding mode switching pulley 69 and the eccentric collar 71 are combined so as to be able to rotate with respect to each other.

As the pounding motor 66 is rotated in the counter-clockwise direction, the pounding mode switching pulley 69 also rotates in the same counter-clockwise direction. At this moment, the eccentric collar 71 is not rotating, its protrusion 711 being in a stationary condition at a specified angular position with respect to the center of the lifting shaft 17. As the pounding mode switching pulley 69 begins to rotate in the counter-clockwise direction in this condition, its end part soon comes to contact the end part of the protrusion 711 of the eccentric collar 71. If the pounding mode switching pulley 69 is further rotated in the counter-clockwise direction, its protrusions 691 come to push the protrusion 711 from the eccentric collar 71 with which it contacts, thereby causing the eccentric collar 71 to also rotate in the counter-clockwise direction. At this moment, the two eccentric collars 71 and 72 on the right-hand and left-hand sides are both displaced in the same direction with respect to the center of the lifting shaft 17. Thus, the links 53 and 54 move in the same manner, as shown in FIG. 12A. Since the ball-supporting arms 4 and 5 are connected similarly to the links 53 and 54 through the arm-supporting members 41 and 42, the massaging balls 3a and 3b on the right-hand side and the massaging balls 3c and 3d on the left-hand side effectuate the pounding at the same time, that is, in the simultaneous pounding mode.

FIG. 13A is a sectional view of the pounding mode switching mechanism for the massaging unit taken along the lifting shaft and FIG. 13B is a sectional view taken along line 13B-13B of FIG. 13A, showing the condition when the pounding motor 66 is rotated in the clockwise direction as seen from the side of the small pulley 67.

As the pounding motor 66 is rotated in the clockwise direction, the pounding mode switching pulley 69 also rotates in the same clockwise direction. At this moment, the eccentric collar 71 is not rotating, its protrusion 711 being in a stationary condition at a specified angular position with respect to the center of the lifting shaft 17. As the pounding mode switching pulley 69 begins to rotate in the clockwise direction in this condition, its end part soon comes to contact the end part of the protrusion 711 of the eccentric collar 71. If the pounding mode switching pulley 69 is further rotated in the clockwise direction, its protrusions 691 come to push the protrusion 711 from the eccentric collar 71 with which it contacts, thereby causing the eccentric collar 71 to also rotate in the clockwise direction. At this moment, there is a phase difference of 180° between the two eccentric collars 71 and 72 with respect to the center of the lifting shaft 17. Thus, the links 53 and 54 move in such a way that there is a phase difference of 180° therebetween, as shown in FIG. 13A. Since the ball-supporting arms 4 and 5 are connected similarly to the links 53 and 54 through the arm-supporting members 41 and 42, the massaging balls 3a and 3b on the right-hand side and the massaging balls 3c and 3d on the left-hand side effectuate the pounding alternately, that is, in the alternate pounding mode. The pounding mode switching pulley 69 and the eccentric collar 71 are together referred to as the phase difference setting device of this invention, and the mode of pounding can be switched, as explained above, by switching the direction of rotation of the pounding motor 66.

If the number of teeth (cogs) is the same on the pounding mode switching pulley 69 and the collar-integrated pulley 37, the ratio of deceleration in the power transmission systems from the pounding motor 66 to them is the same. The ratio of deceleration may be made different, however, between the transmission systems, say, by changing the diameters and/or the numbers of teeth on the pounding mode switching pulley 69 and the collar-integrated pulley 37. In this manner, the phase difference in the motion of the massaging balls on the right-hand side and the left-hand side may be varied. For example, they may be pounding simultaneously but soon the massaging balls on one side will start pounding sooner until they will pound in the alternate pounding mode. Thereafter, their phase difference will continue until they being to pound simultaneously. In other words, the patient will be able to enjoy pounding in a variety of modes.

Friction belts with sectionally V-shaped grooves may be used in these power transmission systems by providing correspondingly V-shaped grooves on the peripheries of the pounding mode switching pulley 69 and the collar-integrated pulley 37. This has the advantage of reducing the noise of operation associated with the power transmission. Alternatively, helical pulleys and helical belts may be used in the power transmission systems for improving the dependability of the timing of motion by the massaging balls on the right-hand and left-hand sides.

1. A massaging machine comprising:
a massaging unit including massaging balls for contacting a patient, a massaging shaft that is rotationally driven for causing said massaging balls to undergo massaging motions, a massaging power source that provides rotary power and rotationally drives said massaging shaft, and a rotation-massaging conversion device that converts said rotary power of said massaging power source into said massaging motions of said massaging balls; and
a lifting mechanism for moving said massaging unit along guide devices, said lifting mechanism including a lifting shaft that is rotated for moving said massaging unit, a moving power source for rotationally driving said lifting shaft and a motion converting device for converting rotary motion of said lifting shaft into movement of said lifting mechanism;
wherein said rotation-massaging conversion device includes a rotation control device that is connected to said lifting shaft and serves to limit rotation of said rotation-massaging conversion device around said massaging shaft.

2. The massaging machine of claim 1 wherein said massaging unit further includes:
pounding rotary bodies that are supported rotatably by said lifting shaft and are rotationally driven for causing said massaging balls to undergo pounding motions;
a pounding power source that provides rotary power for rotationally driving said pounding rotary bodies; and
a rotation-pounding conversion device that converts rotary motions of said pounding rotary bodies into said pounding motions of said massaging balls.

3. The massaging machine of claim 2 further comprising a mode switching mechanism for switching between different modes of said pounding motions by varying direction of rotary motion of said pounding power source.

4. The massaging machine of claim 2 wherein said massaging balls consist of first massaging balls and second massaging balls, said pounding rotary bodies consist of a first rotary body that moves said first massaging balls and a second rotary body that moves said second massaging balls, and said massaging machine further comprises:
a first power transmission system that transmits the rotary power of said pounding power source to said first rotary body; and
a second power transmission system that transmits the rotary power of said pounding power source to said second rotary body.

5. The massaging machine of claim 4 further comprising a phase difference setting device that is provided to at least one of said first power transmission system and said second power transmission system and serves to transmit the rotary power by setting a phase different between said first rotary body and said second rotary body, wherein said mode switching mechanism changes said phase difference by the direction of rotation of said pounding power source.

6. The massaging machine of claim 4 wherein said first power transmission system and said second power transmission system each comprise a toothed belt that is driven by said pounding power source and toothed pulleys around which said belt is wound, and wherein said first rotary body and said second rotary body are rotated by rotary power communicated to said pulleys.

7. The massaging machine of claim 5 wherein said first power transmission system and said second power transmission system each comprise a toothed belt that is driven by said pounding power source and toothed pulleys around which said belt is wound, and wherein said first rotary body and said second rotary body are rotated by rotary power communicated to said pulleys.

8. The massaging machine of claim 4 wherein said first power transmission system and said second power transmission system have different deceleration ratios.

9. The massaging machine of claim 1 wherein said massaging shaft is provided with supporting devices for supporting said massaging unit against said guide devices.

10. The massaging machine of claim 2 wherein said massaging shaft is provided with supporting devices for supporting said massaging unit against said guide devices.

11. The massaging machine of claim 3 wherein said massaging shaft is provided with supporting devices for supporting said massaging unit against said guide devices.

12. The massaging machine of claim 4 wherein said massaging shaft is provided with supporting devices for supporting said massaging unit against said guide devices.

13. The massaging machine of claim 5 wherein said massaging shaft is provided with supporting devices for supporting said massaging unit against said guide devices.

14. The massaging machine of claim 6 wherein said massaging shaft is provided with supporting devices for supporting said massaging unit against said guide devices.

15. The massaging machine of claim 7 wherein said massaging shaft is provided with supporting devices for supporting said massaging unit against said guide devices.

16. The massaging machine of claim 8 wherein said massaging shaft is provided with supporting devices for supporting said massaging unit against said guide devices.

17. The massaging machine of claim 9 wherein said massaging power source and said moving power source are disposed between said massaging shaft and said lifting shaft.

18. The massaging machine of claim 10 wherein said massaging power source and said moving power source are disposed between said massaging shaft and said lifting shaft.

19. The massaging machine of claim 11 wherein said massaging power source and said moving power source are disposed between said massaging shaft and said lifting shaft.

20. The massaging machine of claim 12 wherein said massaging power source and said moving power source are disposed between said massaging shaft and said lifting shaft.

21. The massaging machine of claim 13 wherein said massaging power source and said moving power source are disposed between said massaging shaft and said lifting shaft.

22. The massaging machine of claim 14 wherein said massaging power source and said moving power source are disposed between said massaging shaft and said lifting shaft.

23. The massaging machine of claim 15 wherein said massaging power source and said moving power source are disposed between said massaging shaft and said lifting shaft.

24. The massaging machine of claim 16 wherein said massaging power source and said moving power source are disposed between said massaging shaft and said lifting shaft.
